(19) United States
(12) Patent Application Publication
(10) Pub. No.: US 2002/0087668 A1
(43) Pub. Date: Jul. 4, 2002

(54) Automatic upgrade of live network devices

(76) Inventors: Raul S. San Martin, Ottawa (CA); Michael S. Werner, Victoria (CA); Shane E. Bill, Calgary (CA); Brian J. Stacey, Kanata (CA)

Correspondence Address: DENIS G. MALONEY, Fish & Richardson P.C., 225 Franklin Street, Boston, MA, 02110-2804, US

(21) Appl. No.: 09/751,320

(22) Filed: Dec. 29, 2000

(51) Int. Cl. G06F 15/177; G06F 15/16

(52) U.S. Cl. 709/221; 709/220; 709/218

(57) ABSTRACT

A process and system for the automatic upgrading of a programmable device system in communication with a server, providing new versions of software or components, and verification that new features have been implemented successfully and are working properly in the new version of software, and optionally including backing up and restoring the old software in the event testing results in a critical failure.

### BACKGROUND

This invention relates to computer network devices, and more particularly to the upgrading of software on on-line devices.

Programmable devices that are on-line and connected to a network such as the Internet can require upgrading of software and components such as files and configuration information. Generally upgrading requires that the device be shut-down at an appropriate time, and in the case of servers when no clients are connected, usually late at night or on the weekend and under direct user intervention. After upgrading, tests are usually performed to ensure that the upgraded software or components are working properly and that all new features have been implemented. This often requires that one or more persons be working at late hours or on weekends when usage of the device to be upgraded is at a minimum.

### SUMMARY

In one aspect, the invention relates to an automatic upgrade process which automatically upgrading software stored on a programmable device which may be in communication with a server. The remote programmable device may be another server on a network, or may be a hand held personal digital assistant communicating over a wireless network, or cellular telephone. The upgraded software may be tested, and based upon the results of the testing, either left in the upgraded state or returned to the pre-upgraded state from a backup file. The backup file may be located either on the server or on the remote programmable device, depending upon its capabilities.

In another aspect, the automatic upgrade process is able to send a shutdown request to the remote programmable device to be upgraded, which then shuts down normal operations and enters a state ready to receive further instructions from the automatic upgrade process. The remote programmable device may delay the shutdown process to allow existing users to log off. The automatic upgrade process may also send a restart signal to the remote programmable device which restores it to normal operations, either with or without the upgraded software, depending upon the result of testing.

In yet another aspect, the automatic upgrade process may send a signal to a system operator indicating that the upgrade process is complete. Such a signal may include a paging request or automatic telephone call, depending upon external hardware capabilities of the system on which the automatic upgrade process resides.

In yet another aspect, the automatic update process may be implemented as a computer program application.

In another aspect, the automatic update process is implemented as a computer software product, having instructions on a remote device that will accept requests from an automatic upgrader to shutdown and restart, to receive updated software, and to receive and execute test routines, and local processes that control the operation of the update.

One or more aspects of the invention may include one or more of the following advantages.

The automatic upgrade process supports automatic unattended upgrades without human intervention. It may reduce operations and maintenance costs and it facilitates availability of a production system by checking correct operation of its new features and previous ones through regressive testing.

The automatic update process may be useful in environments where a production server handles requests from clients. Thus, it may be useful on any web-based system (or more generally on any device with a network connection), where on-line servers handle requests from clients on the Internet or Intranet (such as Internet databases, e-commerce solutions, or any such network-based system). In one implementation, the automatic update process uses http requests (and responses) to check for correct system behavior regarding the selected system features. Other communications protocols and methods may be used.

In addition, cost reductions may be realized by avoiding the need for direct human intervention at the time of upgrade. The automatic upgrade process facilitates correct operation of new builds and versions. A network server may be rendered available at needed times without the need for staff to work late hours. It avoids the need for employees having to come to work at late hours or on weekends.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a system block diagram of an architecture for automatic upgrading.

FIG. 2 is a process level block diagram of an automatic upgrading process.

FIG. 3 is a flow chart depicting an automatic upgrading process.

FIG. 4 is an example control screen depicting elements of a graphical user interface for the upgrading process of FIG. 2.

FIG. 5 is an example of a screen that depicts contents of an automatic upgrading log file.

### DETAILED DESCRIPTION

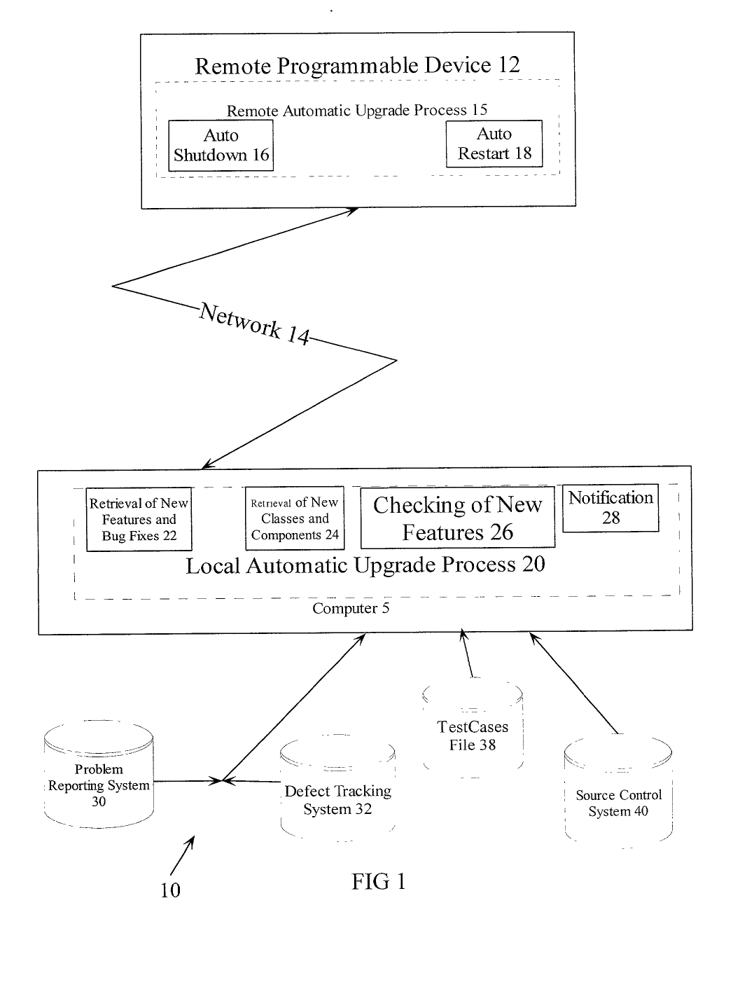

Referring to FIG. 1, an automatic upgrade architecture 10 resides in part on a remote programmable device 12 capable of communicating over a network 14. The remote programmable device includes a remote automatic upgrade process 15, which is comprised of components including an auto shutdown procedure 16 and an auto restart procedure 18.

The remote automatic upgrade process 15 can engage in two-way communication over the network 14 with a computer 518 on which resides local automatic upgrade process 20. The local automatic upgrade process 20 may be implemented in software to be run on computer 5 and on one or more of the remote programmable devices 12. The local automatic upgrade process 20 includes a group of local components including processes for retrieval of bug fixes and new features 22, retrieval of new classes and components 24, checking of new features 26 and notification 28.

The RPD 12 may be any programmable device with re-writeable memory storage and which may engage in two way communications with the local automatic upgrader local process 20. The network 14 may be a local network or a wireless communication network such as a cellular phone network, or other two way communications medium. Other networks providing two way point to point communication serve as well, such as the Internet, wide area networks or even personal digital assistants with wireless modems.

The remote automatic upgrade process 15 components include an auto shutdown procedure 16 which may be implemented as a Java servlet or other software, which runs on the remote programmable device, and which is capable of accepting a request over a network and servicing that request. Upon the RPD receiving an automatic shutdown request from the local automatic upgrade process 20, the automatic shutdown process 16 causes the RPD 12 to shut itself down and restart ready to receive instructions from the local automatic upgrader process 20.

The set of remote automatic upgrade process 15 components also includes an automatic restart 18 process. The automatic restart process 18 restarts the RDP 12 upon receipt of an automatic shutdown request from the local automatic upgrade process 20. The restart may be with updated software, or with the old software restored, depending upon the upgrade process run by the local automatic upgrade process 20, described below. In the case of a web server, this may be achieved by a batch file that starts the web server on the RPD 12. This may also be achieved by another process running on the RPD 12 that will spawn the web server.

The automatic upgrade process 10 also includes local components 20. These local components include retrieval of new features and bug fixes 22 from a problem reporting system 30 or defect tracking system 32. These systems may be resident on computer 518, or available over a network from another computer e.g., a computer server.

The local automatic upgrade process 20 also includes a process to retrieve new classes and components 24. The new classes corresponding to a new software build to be deployed can be automatically extracted from a source control system 40. This system may be a client-server system, or performed by copying files from a given local or remote directory, or by manually copying the files.

The local automatic upgrade process 20 includes a process that supports checking of new features 26. The local automatic upgrade process traverses through a list of test cases 38 that are sent to the RPD 12. This detailed request list of test cases 38 (produced by the user of the automatic upgrade process 10) includes the network address of the RPD to call, parameters to pass; and expected responses to tests (what needs to be present in the response and what cannot be in the response). The local automatic upgrade process 20 may also include a notification process 28 used to issue messages to an attendant. For example, in case of errors, this component can automatically issue a pager request to a support person or it can also automatically make a phone call to this person. In addition, it can send e-mails informing the result of the upgrade (status). Such notification systems may require additional hardware and software not a part of the automatic upgrader process 10.

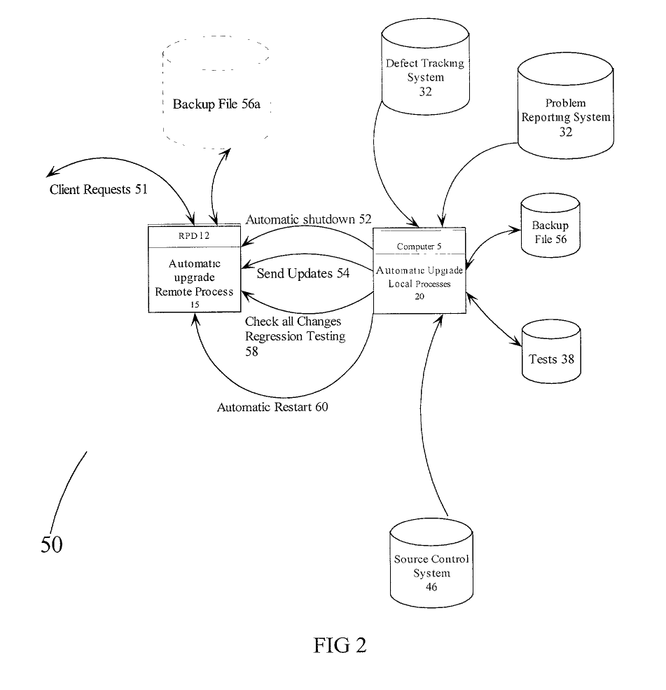

Referring to FIG. 2, an automatic upgrade process 50 is shown. An RPD 12 (such as, for example a production server) is shown on-line and ready to process client requests 51. The automatic upgrade process 50 begins processing a new upgrade, either automatically at a user specified time (usually at a late night hour or during weekend or other non-peak time), or manually upon request.

In order to accomplish the upgrade, it is preferable to be able to cause the RPD 12 to enter a state in which it is no longer servicing client requests 52 and is ready to be updated, backup the existing configuration on the RPD 12 or locally, receive updated files from the local automatic upgrade process 20, test the updates in operation on the RPD 12, and if successful, restore normal operation of the RPD 12 with the updated files. If the update is not successful, it is preferable to be able to restore the prior configuration from the backup files.

The local automatic upgrade process 20 sends an automatic shutdown request signal 56 to shut down the RPD 12. Upon receipt of the automatic shutdown signal, RPD 12 shuts down and restarts in a mode to receive further instructions from the local automatic upgrade process 20. A shut-down procedure 75 may optionally provide advanced warning to possible existing users of the RPD so that they are not using the RPD when it shuts down. A delay period may be defined for such users to complete their current sessions on the RPD, after which delay period the system may complete the shutdown process regardless of the presence of existing users. Alternatively, the shutdown procedure 75 may shift users to other servers by use of a programmable router configured to shift computation amongst a set or cluster of servers (not shown), depending upon the capabilities of the particular RPD 12 and network 14.

After the RPD shuts down and re-starts ready to receive further instructions from the local automatic upgrade process 20, the local automatic upgrade process 20 causes descriptions of classes or components to be read from a source control system 40. The local automatic upgrade process 20 extracts these components and transfers them 54 to the specified RPD 12 that is to be upgraded, together with any bug fixes received from any problem reporting system 30 or defect tracking system 32. The local automatic upgrade process 20 may also make backup copies 56 of the previous classes and configuration. This backup may be done locally at the computer 18, or if the RPD 12 is capable, may be backed 56a on the RPD 12. The local automatic upgrade process 20 causes the computer 518 to read a detailed list of test cases 38 that are associated with the new build features 46 and bugs identified in the problem reporting system 30 or defect tracking system 32. These tests 45 specify in detail the requests that need to be made by the local automatic upgrade process 20 to the RPD 12 and what should or should not be in the RPD's 12 response.

After transferring and installing the upgrades, the local automatic upgrade process 20 initiates upgrade checking 58 based upon the instructions from test case list 38. Testing is done by sending specific requests from the tests file 38 to the RPD 12 to be updated and checking that the correct response is received. If the RPD 12 passes the tests, the local automatic upgrade process 20 sends a restart request 60 to the RPD 12 which executes an automatic restart process 18 by shutting down and restarting itself running the updated software. The local automatic upgrade process 20 then finishes by writing log files, html reports, and/or sending confirmation email messages.

If one or more tests fail, the local automatic upgrade process 20 may restore the previous classes or software components from the local backup file 56 or the remote backup file 56a, and restart the RPD 12 with the previous functional configuration. Whether restoration of a previous configuration is performed depends on the severity of the failed test case, which is defined by instructions in the test case file 38. If indicated by the test case file 38, the new software may be allowed to remain operational if the failed test(s) are noncritical.

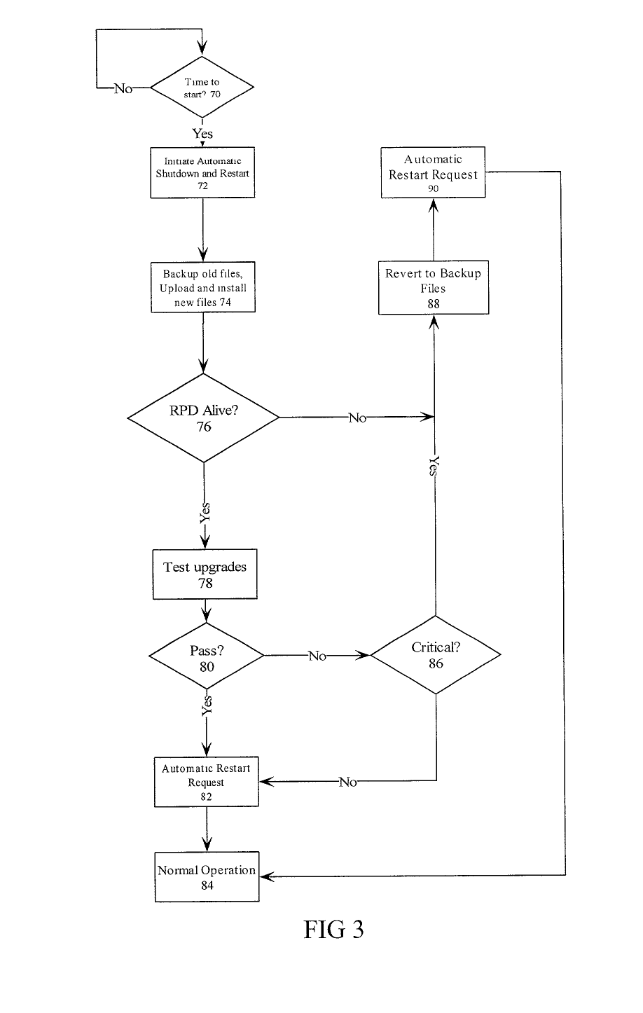

Referring to FIG. 3, the local automatic upgrade process 20 is shown waiting for the time to start an upgrade 70. When it is time to start, the local automatic upgrade process 20 starts an upgrade by sending 72 an automatic shut-down request to the RPD 12 which responds by shutting down and restarting as previously described, ready to communicate further with the local automatic upgrade process 20. The local automatic upgrade process 20 The local automatic upgrade process 20 backs up the programs that are to be updated and uploads and install the new files 74. The local automatic upgrade process 20 verifies that the RPD 12 is on line 76, and if so performs testing 78. If the RPD passes 80 the tests then the local automatic upgrade process 20 sends an automatic restart request 82 to the RPD 12 and the RPD 12 resumes normal operations 84 with the new files.

Optionally, the local automatic upgrade process 20 may initiate a page, telephone or send an e-mail to support personnel and management upon upgrade success or failure and generate status reports (not shown). Such optional services require additional optional capabilities, such as connection to an e-mail server, or access by Internet to a paging service.

If the RPD 12 is not on line 76 or tests fail 80 and the failed tests are critical 86 (as defined in the test files), the automatic upgrade local process 20 causes restoration of the previous files 88. The automatic upgrade process also sends an automatic restart request 90 to the RPD 12, which resumes normal operation 84 with the restored previous files.

Prior to starting the automatic upgrade process 10, a user will develop a test cases file. This file provides information to the automatic upgrade process 10 as to what tests to run, what return strings should be anticipated if the test is successful, and whether the test results are critical, i.e. if unsuccessful, should the updates be removed and the prior system restored. For example, a string may be defined to be sent to the RPD 12, and a response string may be defined which is to be returned if the update is successful. If the response string is not received, the consequence may be defined (i.e. restore the prior state or simply make note of the lack of proper response.) These tests specify in detail the requests that need to be made to the server and what should or should not be in the server's response. These tests may be described using a simple language, such as:

send_request “http://url/path/file?param=new”

response contains “build 10”

response cannot contain “error”

Other languages or scripts can also be used.

In one exemplary implementation, the format for the test file is a text file containing entries of the form

“request:<value>”

The following is a non-limiting example list of fields for defining a test case. Other fields could be defined and used. In this example, fields are entered with the first letter in uppercase, the field immediately followed by a colon and then a space.

Request: The full network path or, in the case of the Internet as the communications network, URL of the RPD.

Response: This is the string that is being sought after and verified when the RPD responds.

Parameter: A non-required field, which is identical to the fields found in forms that send data to the RPD. Depending on the implementation of the item, if not all required fields are specified the test will fail, because an expected message may not be returned. A preferred preparation for defining these parameters is to place information in the actual form set-up in fields desired to be tested, submit the data, and determine the outcome. This is the outcome desired for the upgraded system. All filled in fields are passed to the server; fields that are not filled in are passed containing nothing. For good results, the user should specify all fields in the form even if they are left blank or with a space.

Value: A non-required field, the value is what the parameter is set to. The user specifies the data that was specified in the form to perform manual tests. Again if not all input files in a form are specified, the test case will fail. The test case can either be a Post or Get request. A post will determine whether it is passing the correct information to the server, otherwise the test will send a request and pass information.

Severity: This is the last field, which indicates the end of the test case. The Severity can either be critical or non-critical. If a non-critical test fails, the automatic update process 10 will continue with the update whereas should a critical test fail, the automatic update process 10 will cause reverion the backup.

A non-limiting example test case is shown below:

request: \overline{http://XYZ123:0011/server/salesSubmit}

response: Edit Fred Jones' Account

parameter: user_account

value: \overline{fredjones@XYZcorp.com}

parameter: submit

value: edit

severity: non-critical

request: \overline{http://XYZ123:0011/servlet/salesSubmit}

response: Revert Please!

Severity: Critical

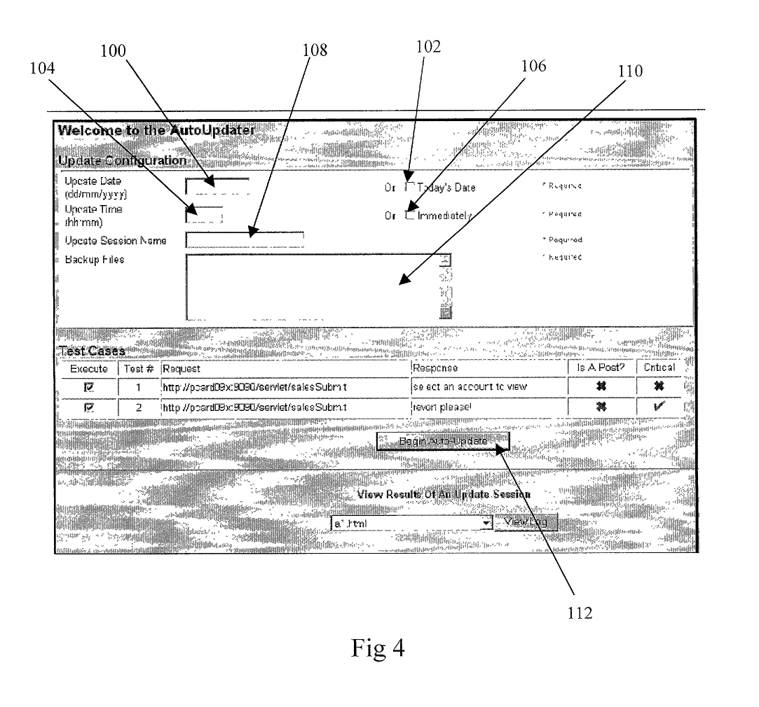

Referring to FIG. 4, an example of one embodiment of a GUI for the automatic upgrade process 10 is shown. The GUI, operating on the computer 5, provides a field for a user to enter a date to have the update commence 100 or the user may select the “Today” checkbox 102 as the date to begin the update. The GUI also has a field to either enter a time to have the update commence 104 or a user may select the Immediately checkbox 106 as the time desired for the update to begin. The time is entered in 24-hour time.

The GUI allows the user to specify the name for the update in the Update Name field 108. The default update name may be any suitable name, such as Bak-mm-dd-yyyy, which represents the current update's month, day, and year. The user specifies the full filename of all the files that will be backed up by the update in the Backup Files field 110. This field will allow the automatic upgrade process 10 process to find all the old builds and place them in the backup directory, as well as move the new build files into the same directory The GUI includes a Begin Auto-Update button 112 to begin the update process. Once the update is in progress, clicking the Stop Update button (not shown) located at the bottom of the GUI stops the update and reverts the RPD to the original saved configuration. Once the update is completed, the local automatic upgrade process 20 will automatically begin the test cases 38.

If a time is specified that is later than the current time then the automatic update system 10 will wait until the specified date and time has occurred before updating. Once an update has been set in automatic upgrade process the current status of that update is shown to a user of the local automatic upgrade process 20.

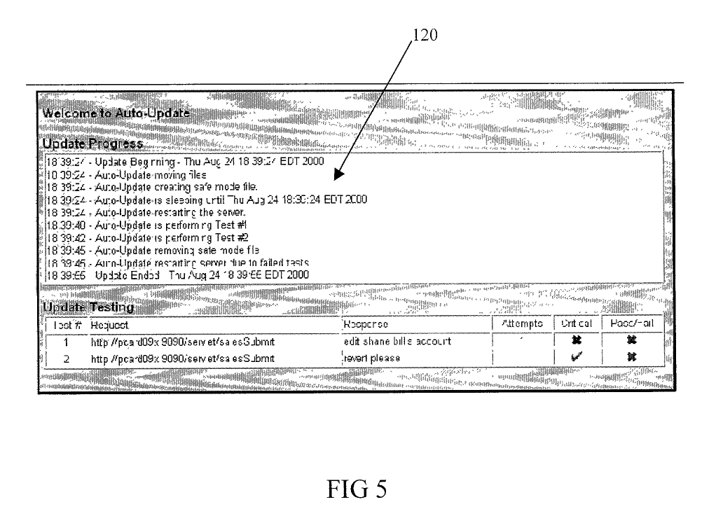

Referring to FIG. 5 an example status page is shown. This status page is updated automatically by the system so the user is able view the status of the update as the update proceeds 120.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform fnmctions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention. For example, communications protocols other than TCP/IP may be used. Devices other than servers may be updated, such as personal digital assistants, cellular phones or even television receivers. Accordingly, other embodiments are within the scope of the following claims.

What is claimed is:

1. A method implemented in a computer program application for updating software on a programmable device, the method comprising:
providing two way communication between a server and the programmable device;
configuring an updating process that executes on the server;
updating the programmable device in accordance with the updating process;
testing the operation of at least a portion of the updated software on the programmable device.

2. The method of claim 1 further comprising
backing up at least a portion of the pre-existing software on the programmable device, and
based upon the testing, restoring the backed portion of the software on the programmable device.

3. The method of claim 2 wherein the backing up occurs on the programmable device.

4. The method of claim 2 wherein the backing up occurs at the server.

5. The method of claim 1 wherein the communications is over the Internet.

6. The method of claim 1 further comprising the server signaling the programmable device to shut down and restart prior to the backing up action.

7. The method of claim 6 wherein there is a user definable delay between the signaling and the shutting down.

8. The method of claim 2 further comprising:
sending a signal to a user based upon an outcome of the testing.

9. A system for updating software on a programmable device comprising:
a server;
a programmable device able to be in two way communication with the server;
the server comprising computer software comprising instructions to cause the server to
configure an update process;
update software on the programmable device in accordance with the update process;
test the operation of at least a portion of the updated software on the programmable device.

10. The system of claim 9 wherein the computer software further comprises instructions to
back up at least a portion of the software on the programmable device;
based upon the testing, restore at least a portion of the backed up software onto the programmable device.

11. The system of claim 10 wherein the back up occurs at the server.

12. The system of claim 9 wherein the communication is over the Internet.

13. The system of claim 9 wherein the computer software further comprises instructions to cause the server to signal the programmable device to shut down and restart prior to the back up.

14. The system of claim 9 wherein a user definable delay between the signaling and the shutting down is provided.

15. A computer program product, tangibly stored on a computer-readable medium, for updating software on a programmable device, comprising instructions operable to cause a programmable processor to:
configure an update process;
communicate with the programmable device over a two way communications medium;
backup at least a portion of the software on the programmable device;
update software on the programmable device in accordance with the update process;
test the operation of at least a portion of the updated software on the programmable device.

16. The product of claim 15 further comprising computer software comprising instructions to cause the server to restore at least a portion of the backed up software on the programmable device based upon the testing.

17. The product of claim 16 wherein back up occurs on the programmable device.

18. The product of claim 16 wherein the backing up occurs at the server.

19. The product of claim 15 wherein the communication is over the Internet.

20. The product of claim 15 further comprising instructions operable to cause a programmable processor to cause the server to signal the programmable device to shut down and restart prior to the backing up step.

21. The product of claim 20 wherein there is a user definable delay between the signaling and the shutting down.

22. The method of claim 15 further comprising instructions to:
send a signal to a user based upon a testing outcome.
